(19) United States
(12) Patent Application Publication
(10) Pub. No.: US 2008/0298882 A1
(43) Pub. Date: Dec. 4, 2008

(54) LOOSE-LEAF BINDING STRUCTURE

(76) Inventor: Yu-Sheng Huang, Banciao City (TW)

Correspondence Address: SCHMEISER, OLSEN & WATTS, 22 CENTURY HILL DRIVE, SUITE 302, LATHAM, NY, 12110, US

(21) Appl. No.: 11/754,609

(22) Filed: May 29, 2007

(51) Int. Cl. B42F 3/04

(52) U.S. Cl. 402/68

(57) ABSTRACT

A loose-leaf binding structure comprises: a connecting unit with hooks, each having a first bent plate, a second bent plate corresponding to the first bent plate, and an arc plate connected to the first and second bent plates, and each arc plate has a connecting portion proximate to the second bent plate and connected to each hook; and a position limit unit, having a guide track on each side of the position limit unit, such that the position limit unit is movably coupled to first and second bent plates by the guide track. Each hook passes through the loose pages and binds the covers between the first and second bent plates and the position limit unit, and thus hiding the connecting unit to give a loose-leaf binder with a flat and even surface, and allowing users to dispose the binder neatly and flatly or writing on the loose page easily.

### FIELD OF THE INVENTION

The present invention relates to an improved loose-leaf binding structure, and more particularly to a loose-leaf binder having a flat and even surface, such that loose pages can be stacked neatly with each other and the binder can be spread out flatly to facilitate users to write on the loose pages.

### BACKGROUND OF THE INVENTION

Referring to FIGS. 1 and 2 for a general conventional loose-leaf binder, the loose-leaf binder includes a plurality of hooks 5 parallel to each other, a straight plate 6 connected to an end of each hook, and a stop plate 7 slidably disposed on another end of the hook and the straight plate 6, such that loose pages 3 and covers 4, 4a on both sides of the loose pages 3 are passed through by each hook 5 and slidably disposed on an end of the hook 5 and the straight plate 6 by the stop plate 7 to constitute a loose-leaf binder capable of quickly binding or removing the loose pages 3 and the covers 4, 4a (as shown in FIG. 3).

Although the aforementioned conventional loose-leaf binder composed of a plurality of hooks 5, a straight plate 5 and a stop plate 7 can bind and remove loose pages 3 and covers 4, 4a quickly, yet, the lateral side of each hook 5 with specific volume and curvature is exposed from the of the covers 4, 4a of the loose-leaf binder, so that the loose-leaf binder has a lateral cambered surface after the loose pages 3 and covers 4, 4a are bound to each hook to form a loose-leaf binder. As a result, when the loose-leaf binder is disposed on a surface or stacked on another binder, a gap is formed between the lateral side of the hooks and the flat disposing surface or between two loose-leaf binders. Since the lateral cambered surface has a gap, the loose-leaf binder cannot be disposed flatly on a surface. If a user puts such loose-leaf binder in a backpack, then the lateral side of the hooks 5 may hook to other objects and makes the access of the loose-leaf binder very inconvenient.

### SUMMARY OF THE INVENTION

In view of the shortcomings of the prior art, the inventor of the present invention based on years of experience in the related industry to conduct researches and experiments, and finally developed an improved loose-leaf binding structure in accordance with the present invention to overcome the shortcomings of the prior art.

Therefore, it is a primary objective of the present invention to provide a loose-leaf binder that binds loose pages and covers between first and second bent plates and a position limit unit for hiding a connecting unit, so that the loose-leaf binder has a flat and even surface to achieve the effects of disposing the binder flatly and neatly on a disposing surface, and allowing the loose pages to be spread open flatly for facilitating users to write on the loose pages.

To achieve the foregoing objective, the present invention provides an improved loose-leaf binding structure, comprising: a connecting unit having a plurality of hooks, and each hook comprises a first bent plate, a second bent plate connected to the corresponding first bent plate, and an arc plate connected to the first and second bent plates, and each arc plate has a connecting portion disposed at an appropriate position proximate to the second bent plate and connected to each hook; and a position limit unit, having a guide track separately disposed on both laterals sides of the position limit unit and movably coupled to the first and second bent plates. The above and other objects, features and advantages of the present invention will become apparent from the following detailed description taken with the accompanying drawing.

### BRIEF DESCRIPTION OF THE DRAWINGS

FIG. 1 is an exploded view of a prior art;

FIG. 2 is a perspective view of a prior art;

FIG. 3 is a perspective view of an assembled structure of a prior art;

FIG. 4 is an exploded view of the present invention;

FIG. 5 is a perspective view of the present invention;

FIG. 6 is a schematic view of assembling the present invention;

FIG. 7 is a perspective of an assembled structure of the present invention;

FIG. 8 is a section view of an assembled structure of the present invention; and

FIG. 9 is a section view of another assembled structure of the present invention.

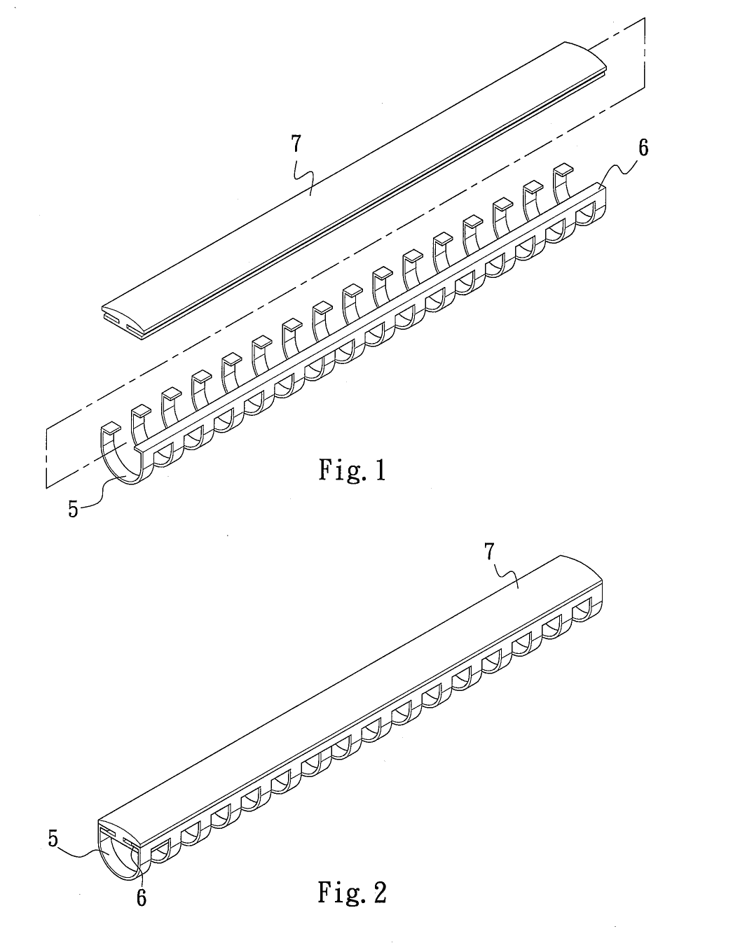

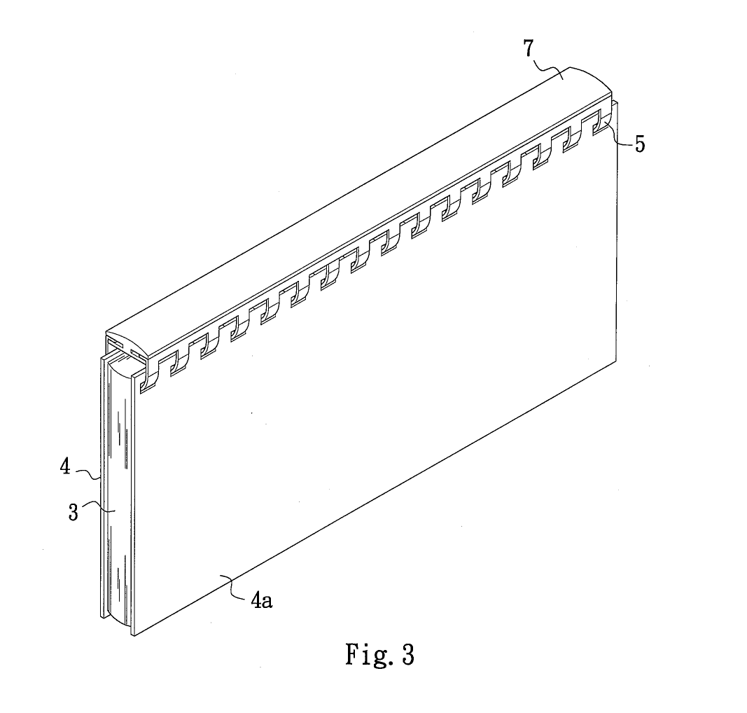

### DETAILED DESCRIPTION OF THE PREFERRED EMBODIMENTS

To make it easier for our examiner to understand the objective, innovative features and performance of the present invention, we use preferred embodiments and the accompanying drawings for a detailed description of the present invention.

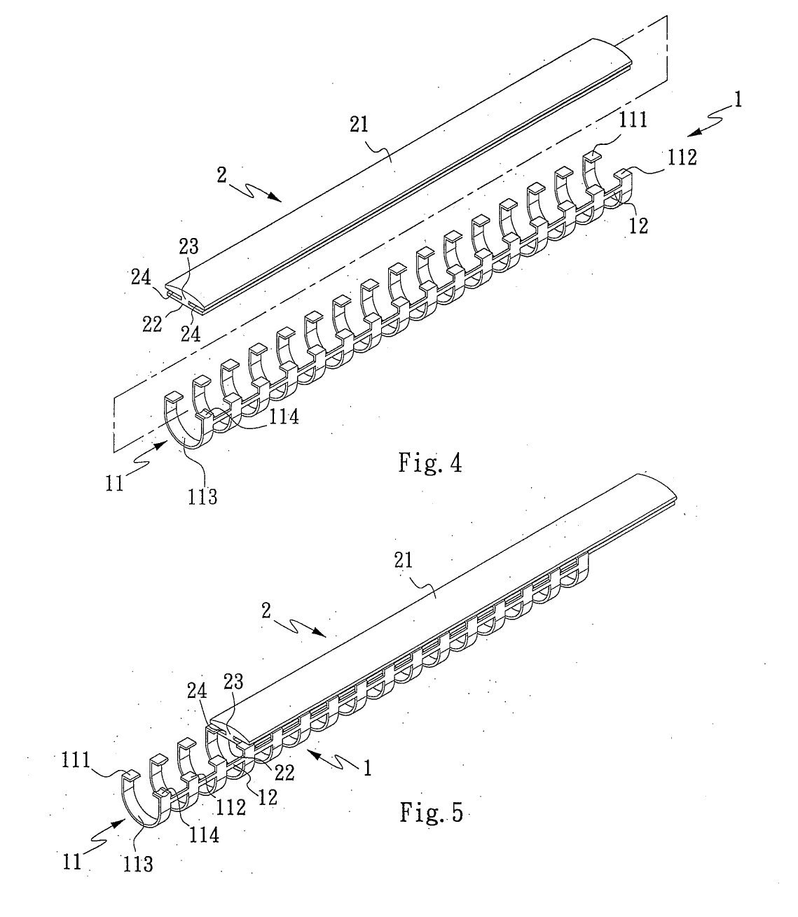

Referring to FIGS. 4 and 5 for an exploded view and a perspective view of the present invention respectively, the present invention provides an improved loose-leaf binding structure, comprising: a connecting unit 1 and a position limit unit 2.

The connecting unit 1 has a plurality of hooks 11, and each hook 11 comprises a first bent plate 111, a second bent plate 112 disposed on the same plane and corresponding to the first bent plate 111, and an arc plate 113 connected to the first and second bent plates 111, 112, and each arc plate 113 has a connecting portion 12 disposed at an appropriate position proximate to the second bent plate 112 and connected to each hook 11, wherein the surface of each of the first and second bent plates 111, 112 has a cambered surface portion 114 according to the actual need.

The position limit unit 2 comprises a top plate 21, a bottom plate 22 corresponding to the top plate 21, and a partition 23 disposed between the top and bottom plates 21, 22 for forming two guide tracks 24 between the top and bottom plates 21, 22, and each guide track 24 is movably coupled to the first and second bent plates 111, 112. With the foregoing components, a novel improved loose-leaf binding structure is formed to achieve a simple structure and an easy manufacturing effect.

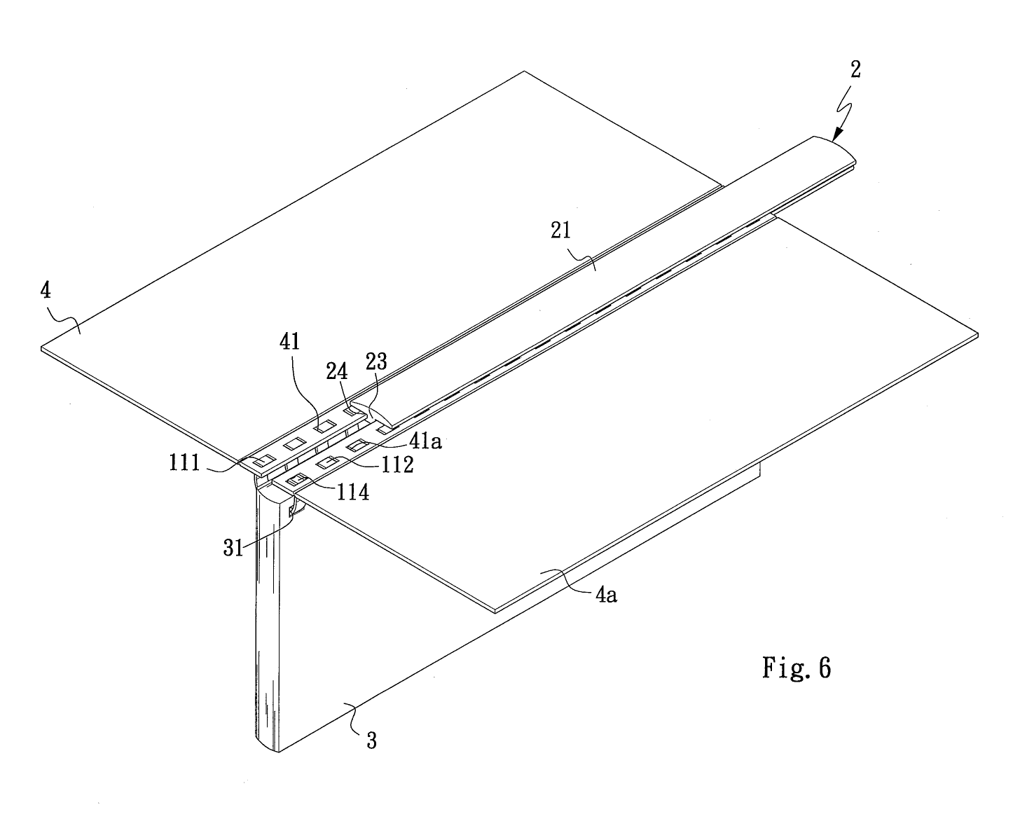

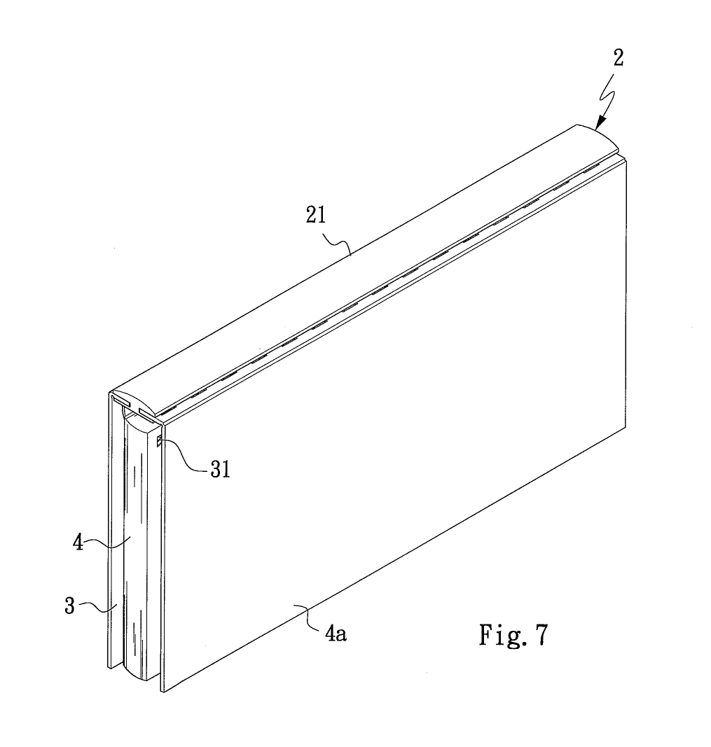

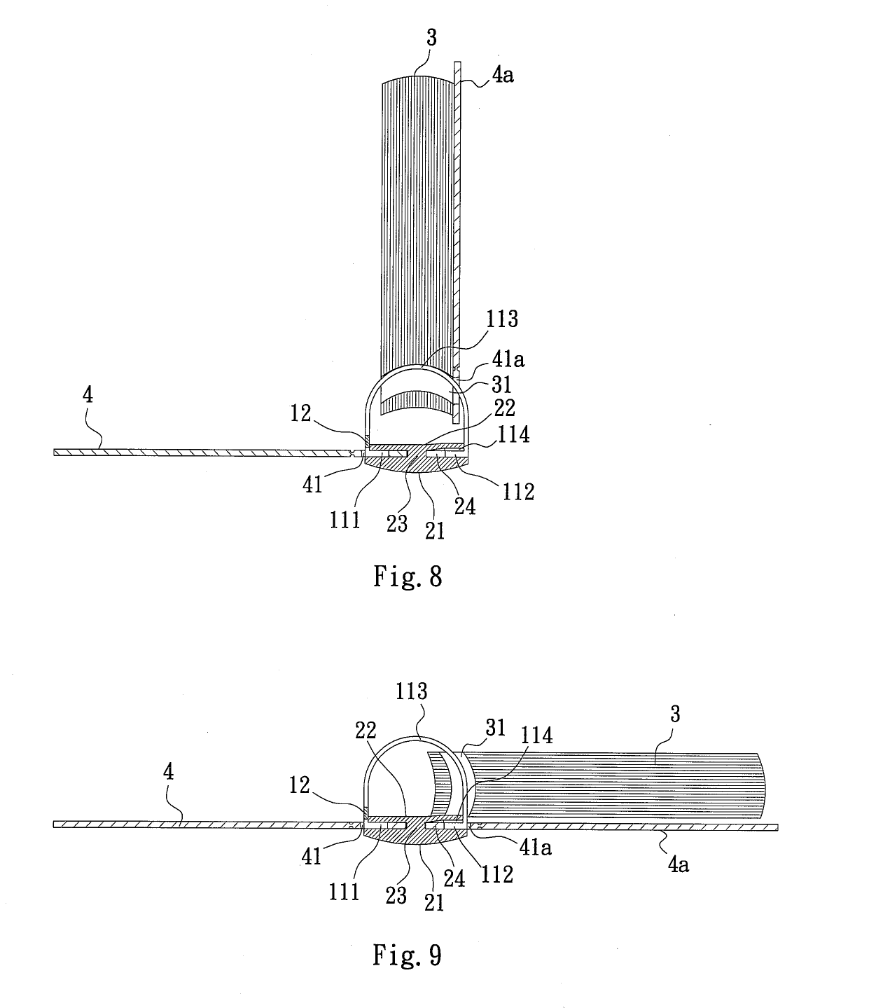

Referring to FIGS. 6 to 8 for a schematic view, a perspective view and a section view of an assembled structure of the present invention respectively, a first bent plate 111 of each hook 11 of a connecting unit 1 is passed through a through hole 31 disposed on a side of each of the plurality of loose pages 3 when the present invention is used, so that each through hole 31 of the loose page 3 is hung onto an arc plate 113 of each hook 11, and then each through hole 41, 41a of two covers 4, 4a corresponds to the lateral side of the periphery of the first and second bent plates 111, 112, and the guide tracks 24 on both sides of the position limit unit 2 are slid into corresponding distal edges of the first and second bent plates 111, 112, such that a side of the two covers 4, 4a and the first and second bent plates 111, 112 are embedded into the guide tracks 24 on both sides of the position limit unit 2 respectively, wherein a cambered surface portion 114 on the surface of the first bent plate 111 (or the second bent plate 112) and the guide track 24 are interfered with each other, and thus the position limit unit 2 can be embedded securely onto the connecting unit 1 to constitute a loose-leaf binder. When each cover 4, 4a is covered in a direction towards the loose pages 3, each hook 11 on the connecting unit 1 is hidden by the covers 4, 4a on both sides of the hook 11 and each hook 11 will not be exposed, so as to give a flat and even surface to the loose-leaf binder and achieve the effects of neatly disposing or stacking the binders, flatly spreading open the loose pages and facilitating users to write on the loose pages.

Referring to FIG. 9 for a section view of another assembled structure of the present invention, a cover 4a together with the loose pages 3 are hung on each hook 11 when the present invention is used, and only a side of the cover 4a corresponds to the periphery of the first bent plate 111, such that after the guide tracks 24 on both sides of the position limit unit 2 are embedded into the first and second bent plates 111, 112, the cover 4 hides a side of each hook 11 to meet the practical application of the present invention.

In summation of the description above, the improved loose-leaf binding structure of the invention can effectively overcome the shortcomings of the prior art by passing each hook of the connecting unit through the loose pages, and binding the required covers between the first and second bent plates and the position limit unit to constitute a loose-leaf binder, and the connecting unit is hidden to give a flat and even surface to the loose-leaf binder, so as to achieve the effects of neatly disposing or stacking the binders, flatly spreading open the loose pages, and facilitating users to write on the loose pages.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An improved loose-leaf binding structure, comprising:
a connecting unit, having a plurality of hooks, and each hook comprises a first bent plate, a second bent plate corresponding to the first bent plate, and an arc plate connected to the first and second bent plates, and each arc plate has a connecting portion disposed at an appropriate position proximate to the second bent plate and connected to each hook; and
a position limit unit, having a guide track separately disposed on both laterals sides of the position limit unit and movably coupled to the first and second bent plates.

2. The improved loose-leaf binding structure of claim 1, wherein each first and second bent plates has a cambered surface portion according to the actual need.

3. The improved loose-leaf binding structure of claim 1, wherein each of the first and second bent plates is disposed on the same plane.

4. The improved loose-leaf binding structure of claim 1, wherein the position limit unit comprises a top plate, a bottom plate corresponding to the top plate, and a partition disposed between the top and bottom plates, such that two guide tracks are formed between the top and bottom plates.
